(19) United States
(12) Patent Application Publication
(10) Pub. No.: US 2019/0041905 A1
(43) Pub. Date: Feb. 7, 2019

(54) ERGONOMIC MONITOR BRACKET

(71) Applicant: Walmart Apollo, LLC, Bentonville, AR (US)

(72) Inventor: Yurgis Mauro Bacallao, Centerton, AR (US)

(21) Appl. No.: 16/039,918

(22) Filed: Jul. 19, 2018

Related U.S. Application Data
(60) Provisional application No. 62/541,885, filed on Aug. 7, 2017.

(51) Int. Cl. G06F 1/16; F16M 11/04; F16M 13/02

(52) U.S. Cl. CPC G06F 1/1611; F16M 11/04; G06F 1/1656; G06F 2200/1633; F16M 13/022

(57) ABSTRACT

A bracket for holding signs adjacent a screen of a television monitor on display at a retail store is described. A triangular support structure has struts which connect to the universal wall mounts of the monitor. An extension arm adapted to hold a sign is pivotally connected to triangular support allowing it to pivot with respect to the monitor. A biasing means urges the extension arm toward the screen of the monitor. If the monitor begins to fall, the extension arm is pulled by the biasing means to pivot toward the screen to protect the screen from damage in the event that the monitor falls on an object. It may also include a trigger lever at the base of the monitor which pulls a connection link which releases a catch allowing the extension arm to pivot.

### RELATED APPLICATIONS

This application claims the benefit of U.S. Provisional Patent Application No. 62/541,885, filed Aug. 7, 2017, entitled “Monitor Bracket”, the contents of which are incorporated by reference herein to the extent that it does not conflict with the current application.

### FIELD

Aspects of the present invention relate to a device for displaying signage near a monitor, and more specifically to a device for displaying signage near a monitor that acts to protect the monitor in the event it is knocked over.

### BACKGROUND

### Attaching Signage

When selling in a retail environment, it is beneficial to be able to communicate to the potential buyer in a quick and easy way the benefits and features of each product. Typically, when selling televisions, the customers are attracted to the screen. The retailer would like to allow the entire screen to be visible and typically attach the signs to the border area around the screen. This allows the signs to be placed near the screen, without blocking the screen.

Large flat screen televisions or monitors have a front side that is essentially all screen with little border areas. Therefore, the retailer must devise different means of attaching signage to the monitor that will be displayed near the screen. The retailer is reluctant to use clips or other attachments which clamp to the screen, so as not to scratch the screen. Since there is not much perimeter room left to attach any structures which can hold signs, the retailer must improvise each time to mount signs. The sign should also be positioned near, but not covering the screen so as to catch the attention of a potential buyer.

Since the models change continuously, the retailer must continuously develop new means of holding signs near the screen of each of the new designs.

Currently there is a need for structures which can attach universally to monitors and hold signage at the proper location.

### Monitor Damage

Another problem with displaying large flat screen monitors is that due to their large dimensions and height, they are unstable. Some of the larger, new models can become very expensive. These larger models, due to their size, tend to be knocked over more easily. If a monitor is knocked over, there is a possibility that the large screen may hit another object, breaking, cracking or causing scratches to the screen.

Currently there is a need for a device that would protect large screen monitors when they are put on display for sale.

### BRIEF SUMMARY

According to aspects of the present inventive concepts there is provided an apparatus and method as set forth in the appended claims. Other features of the inventive concepts will be apparent from the dependent claims, and the description which follows.

In one embodiment, there is described an ergonomic monitor bracket which may be referred to simply as a “monitor bracket”, adapted for attaching a sign to a monitor and for preventing damage to the monitor having a triangular support structure with a first elongated strut, a second elongated strut. The distal end of the second elongated strut is connected to the distal end of the first elongated strut at an acute angle. It also includes a pivot attached to the distal ends of the struts. An attachment device at the proximal end of the first elongated strut and the second elongated strut attaches them to wall mount holes in a rear side of the monitor, thereby securing the monitor bracket to the monitor. An extension arm has a proximal end that is connected to the pivot allowing the extension arm to extend out from the monitor in a first position, and pivot toward a front side of the monitor in a second position. The distal end has a sign connection structure adapted to secure and hold the sign. A biasing means, biases the extension arm toward a first position when the monitor is upright, and biases the extension arm toward the second position and the sign to cover and protect the screen of the monitor in the event that the monitor falls toward the front (screen) side.

In another embodiment, there is described a monitor bracket adapted to attach a sign to a monitor, and that prevents damage to the monitor having a triangular support structure with a first elongated strut having a proximal end and a distal end, and a second elongated strut having a proximal end and a distal end. The distal end of the second elongated strut is connected to the distal end of the first elongated strut at an acute angle. An attachment device is adapted to attach the proximal end of the first elongated strut and the second elongated strut to wall mount holes in a rear side of the monitor, thereby securing the monitor bracket to the monitor. A trigger lever is attached to the bottom of the monitor, that interacts with a connection link so as to move the connection link when the monitor is being tilted. An extension arm has a proximal end and a distal end wherein the proximal end is connected to the pivot allowing the extension arm to extend out from the monitor in a first position, and pivot toward a front side of the monitor into a second position. The distal end of the extension arm has a sign connection structure adapted to secure and hold the sign. A biasing means, biases the extension arm toward the second position in which the sign covers and protects the monitor screen. A latch adapted to interact with the connection link and hold the extension arm against the biasing means in the first position extending it to allow the sign to be displayed, and to allow the biasing means to rotate the extension arm into the second position covering and protecting the monitor screen when the connection link has been moved.

The current invention may also be embodied as a method of attaching a sign to a monitor while protecting a front side of the monitor having a screen from damage by providing at least two struts each having a proximal end attached to a wall mounting recess on a back side of the monitor, with their other ends, the distal ends, attached together forming a triangular shape, pivotally connecting a proximal end of an extension arm to the distal ends of the struts, and attaching a sign to the distal end of the extension arm. This method also includes biasing the extension arm into a display position when the monitor is upright, and biasing the extension arm toward a protective position in which the sign covers and protects the screen in the event that the monitor falls forward.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates a perspective view from the rear of one embodiment of a monitor bracket in its display position attached to a monitor in accordance with the present invention.

FIG. 2 illustrates a side elevational view of one embodiment of a monitor bracket in its display position in accordance with the present invention.

FIG. 3 illustrates a side elevational view of the embodiment of a monitor bracket shown in FIG. 2 just as it begins to fall.

FIG. 4 illustrates a side view of the embodiment of a monitor bracket shown in FIGS. 2 and 3 that has folded into its protective position protecting the screen of the monitor when tipped over.

FIG. 5 illustrates a side elevational view of another embodiment of a monitor bracket in its display position in accordance with the present invention.

FIG. 6 illustrates a side elevational view of the embodiment of a monitor bracket shown in FIG. 5 just as it begins to fall.

FIG. 7 illustrates a side view of the embodiment of a monitor bracket shown in FIGS. 5 and 6 that has fallen and has changed to its protective position protecting the screen of the monitor.

### DETAILED DESCRIPTION

### Theory

Since there are many different models of television monitors being released, retailers are constantly putting up new displays for the new models. Each of those has features which the retailer would like to advertise. Since these models vary, the retailer must devise new methods of attaching signs to the monitors. This can become time-consuming. The current invention provides a standard method of attaching signs which will work with many different models of monitors.

Flat television monitors keep getting larger and thinner. Due to their dimensions, they are easily tipped. They are also very fragile, especially their screens. Retailers are losing a considerable amount of revenue due to customers accidently tipping and breaking monitors that are on display. The current invention provides a device which flips the sign over the monitor screen to protect the screen when it falls.

### Implementation

The current invention is shown and described as several embodiments.

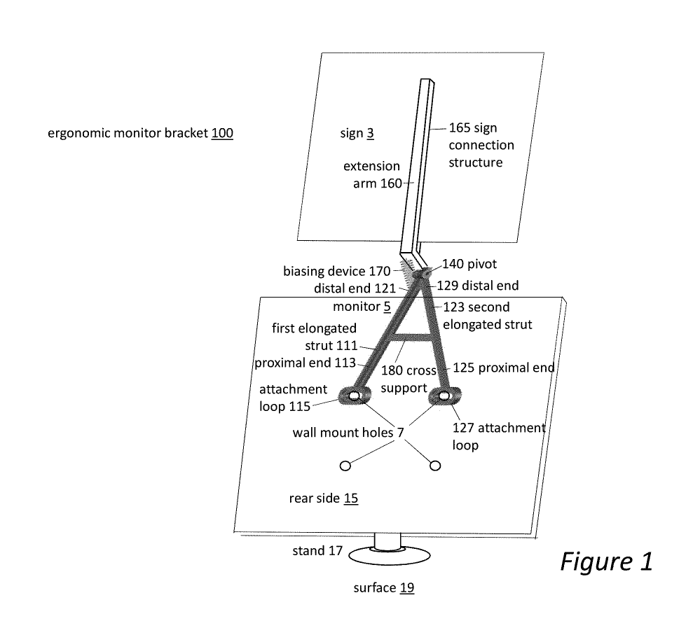

FIG. 1 illustrates a perspective view from the rear of one embodiment of a monitor bracket 100 in its display position attached to a monitor 5 in accordance with the present invention.

A television monitor or computer display monitor 5 supported by a stand 17 on a surface 19 is shown in FIG. 1. A rear side 15 of monitor 5 is visible from this perspective. It shows wall mount holes 7. The monitor bracket 100 includes a first elongated strut 111 that has a proximal end 113 and a distal end 129. The distal ends 121, 129 are connected to produce a triangular shape. The proximal ends 113, 125 of elongated struts 111, 123 have an attachment loop 115 allowing the elongated struts 111, 123 to be attached to wall mount holes 7 of monitor 5. Distal ends 121, 129 of the elongated struts 111, 123 may be pivotally attached to each other allowing attachment loops 115, 127 to be placed at a different distance from each other. Preferably these are spaced by the standard horizontal or vertical spacing between wall mount holes 7, or are adjustable to fit either.

An extension arm 160 is pivotally connected to distal ends 121, 129, first elongated strut 111 and second elongated strut 123 at a pivot 140. This pivot allows the extension arm 160 to rotate about a horizontal axis which is substantially parallel to the plane of the monitor 5.

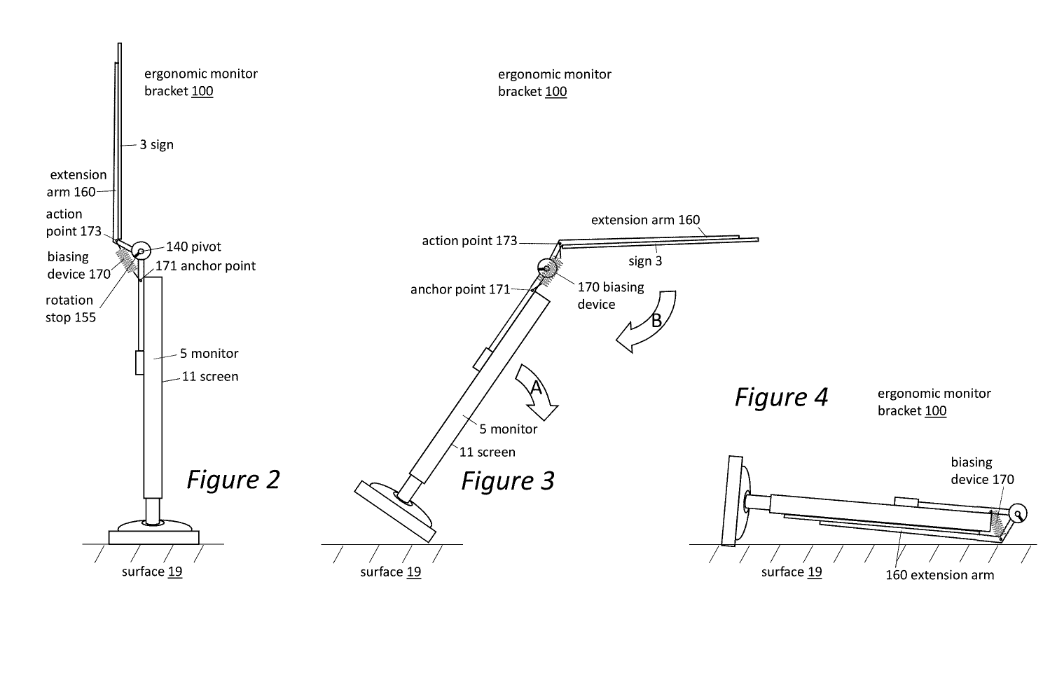

The extension arm 160 has a sign connection structure 165, which may be a slot or other device capable of holding sign 3. A biasing device 170, which may be a spring attaches to an anchor point (171 of FIGS. 2, 3) on one of the distal ends 121, 129 of the elongated struts 111, 123. The other side of biasing device 170, attaches to an action point (173 of FIGS. 2, 3) on extension arm 160. Biasing device 170 causes extension arm 160 to rotate towards the rear side 15 of monitor 5. Pivot 140 includes a rotation stop (155 of FIG. 2) which stops rotation of extension arm 160 such that sign 3 is extended and visible from a front side of monitor 5. This position of the monitor bracket 100 is considered the ‘display position’.

Monitor 5, monitor bracket 100, and sign 3 are all supported by stand 17 of monitor 5.

FIG. 2 illustrates a side elevational view of one embodiment of a monitor bracket 100 in its display position in accordance with the present invention. In this view, biasing device 170, shown here as a tension spring, attaches to at least one of the elongated struts 111, 123 at an anchor point 171. The other end of biasing device 170 is attached to an action point 173. Since the action point 173 and anchor point 171 are both on the left side of pivot 140, it biases extension arm 160 to move in a counter-clockwise manner around pivot 140. Extension arm 160 moves to a point where a rotation stop 155 stops pivot 140 from rotating any farther.

It takes some force to rotate extension arm 160 in a clockwise direction about pivot 140 up until the action point 173 is directly on the opposite side of pivot 140 as the anchor point 171, since it would extend biasing device 170. Once extension arm 160 rotates past this point, the biasing device 170 would then bias extension arm 160 in a clockwise direction.

FIG. 3 illustrates a side elevational view of the embodiment of a monitor bracket 100 shown in FIG. 2, just as it begins to fall. If the monitor 5, sign 3 and bracket 100 are tipped over in the direction marked by arrow “A”, the weight of the sign 3 causes it to move in the direction of arrow “B”. It rotates past the point where the anchor point 171 and the action point 173 are on the opposite side of pivot 140. Once, past this point, biasing device 170 causes extension arm 160 and sign 3 to continue to rotate in a clockwise direction about pivot 140 until sign 3 covers screen 11. The biasing device 170 should have a force selected to be able to rotate extension arm 160 and sign 3 quickly enough to cover screen 11 before it hits the ground or other objects.

FIG. 4 illustrates a side view of the embodiment of a monitor bracket 100 shown in FIGS. 2 and 3 that has folded into its protective position protecting the screen of the monitor when tipped over. Extension arm 160 and sign 3 are now at least partially covering the screen of the monitor 5, protecting it.

The locations of the anchor point 171 and action point 173 should be selected such that the weight of the tilted extension arm 160 and sign 3 will stand in the display position when the monitor is upright, but cause them to rotate according to arrow “B” when the monitor 5 is tipped.

In an alternative embodiment, pivot 140 may also have an additional rotation stop which locks the extension arm 160 at some point between its display position and its position shown in FIG. 4. In this embodiment, the extension arm 160 and sign 3 hit the surface and prevent the screen 11 from hitting the surface 19 or other object on the surface 19.

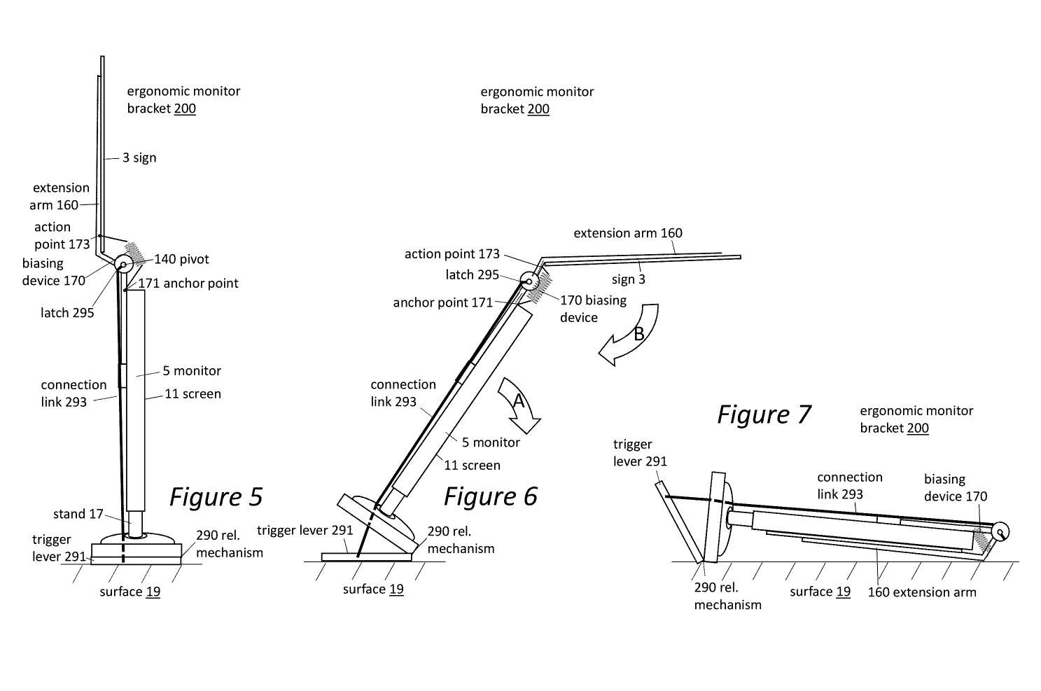

FIG. 5 illustrates a side elevational view of another embodiment of a monitor bracket 200, which may be simply referred to as a “monitor bracket”, in its display position in accordance with the present invention. Like numbered elements across the figures have similar structure and function.

The monitor bracket 200 of FIGS. 5-7 has many of the same structures as the like numbered elements of FIGS. 2-4 and operate in a similar manner. However, instead of relying on the weight of sign 3 and extension arm 160 to trigger rotation toward the screen 11, that monitor bracket 100 employs, the monitor bracket 200 employs a release mechanism 290 having a trigger lever 291, connection link 293 and latch 295. In FIG. 5, the monitor bracket 200 is in its ‘display position’ with a latch 295, which may be any conventional latch which can hold the extension arm 160 in place against the force of biasing device 170. In this embodiment, biasing device 170 is on the side of monitor 5 having screen 11. In FIG. 5, trigger lever 291 is fully folded and allows connection link 293 to be fully extended. The fully extended connection link 293 allows latch 295 to hold extension arm 160 and sign 3 in their display position.

FIG. 6 illustrates a side elevational view of the embodiment of a monitor bracket 200 shown in FIG. 5 just as it begins to fall. Trigger lever 291 is allowed to open and pull connection link 293. This retracts connection link 293 and releases latch 295. This allows extension arm 160 and sign 3 to rotate according to arrow “B” toward screen 11.

FIG. 7 illustrates a side view of an embodiment of the monitor bracket shown in FIGS. 5 and 6 that has fallen and has changed to its protective position protecting the screen 11 of the monitor 5.

In an alternative embodiment, pivot may have a stop which stops rotation of extension arm 160 such that it may lock in a position such that it prevents the monitor 5 from hitting the surface 19.

Although a few examples have been shown and described, it will be appreciated by those skilled in the art that various changes and modifications might be made without departing from the scope of the invention, as defined in the appended claims.

What is claimed is:

1. A monitor bracket adapted for attaching a sign to a monitor, and for preventing damage to the monitor comprising:
a triangular support structure comprising:
a first elongated strut having a proximal end and a distal end;
a second elongated strut having a proximal end and a distal end, wherein the distal end is connected to the distal end of the first elongated strut at an acute angle;
a pivot attached to the distal ends of the struts;
an attachment device at the proximal end of the first elongated strut, and the second elongated strut adapted to attach their proximal ends to wall mount holes in a rear side of the monitor, thereby securing the monitor bracket to the monitor;
an extension arm having a proximal end and a distal end,
wherein the proximal end is connected to the pivot allowing the extension arm to extend out from the monitor in a first position, and pivot toward a front side of the monitor in a second position; and
wherein the distal end has a sign connection structure adapted to secure and hold the sign;
a biasing means, biasing the extension arm toward a first position when the monitor is upright, and biasing the extension arm toward the second position and the sign 3 to cover and protect the screen of the monitor in the event that the monitor falls toward the front side.

2. The monitor bracket of claim 1, further comprising:
a cross support connected between the first elongated strut and the second elongated strut, making the monitor bracket more rigid.

3. The monitor bracket of claim 1, wherein the struts are pivotally connected and can change the angle between the struts to cause the proximal ends of the struts to have a distance between them that is substantially equal to a vertical spacing between the wall mount holes of a standard wall mount pattern.

4. The monitor bracket of claim 1, wherein the first elongated strut and the second elongated strut are pivotally connected and can change the angle between them to cause the proximal ends to have a distance between them that is substantially equal to a horizontal spacing of the wall mount holes of a standard wall mount pattern.

5. The monitor bracket of claim 1, wherein the cross support can be adjusted to allow the proximal ends of the struts to have a width substantially equal to a width of the wall mount holes of a standard wall mount pattern.

6. The monitor bracket of claim 1,
wherein the proximal end of the first elongated strut has an attachment loop and the proximal end of the second elongated strut has an attachment loop; and
the wherein the attachment device further comprises:
a threaded attachment device being one of a screw, bolt and stud that fits through each attachment loop and is secured in the wall mount hole.

7. The monitor bracket of claim 6, wherein the threaded attachment device is a
a tamper-resistant threaded attachment device that fits through each attachment loop and is secured into a wall mount hole.

8. The monitor bracket of claim 1, wherein at least one of the first elongated strut, the second elongated strut, the, pivot and extension arm are constructed from a recyclable material.

9. A monitor bracket adapted to attach a sign to a monitor, and for preventing damage to the monitor comprising:
a triangular support structure comprising:
a first elongated strut having a proximal end and a distal end;
a second elongated strut having a proximal end and a distal end, wherein the distal end of the second elongated strut is connected to the distal end of the first elongated strut at an acute angle;
an attachment device adapted to attach the proximal end of the first elongated strut and the second elongated strut to wall mount holes in a rear side of the monitor, thereby securing the monitor bracket to the monitor;
a trigger lever on a bottom of the monitor, adapted to interact a connection link so as to move the connection link when the monitor is being tilted;
an extension arm having a proximal end and a distal end,
wherein the proximal end is connected to the pivot allowing the extension arm to extend out from the monitor in a first position, and pivot toward a front side of the monitor into a second position; and
wherein the distal end of the extension arm has a sign connection structure adapted to secure and hold the sign;
a biasing means, biasing the extension arm toward the second position in which the sign covers and protects the monitor screen
a latch adapted to interact with the connection link and hold the extension arm against the biasing means in the first position extending it to allow the sign to be displayed, and to allow the biasing means to rotate the extension arm into the second position covering and protecting the monitor screen when the connection link has been moved.

10. The monitor bracket of claim 1, further comprising:
a cross support connected between the first elongated strut and the second elongated strut, making the bracket more rigid.

11. The monitor bracket of claim 1, wherein the first elongated strut and the second elongated strut are pivotally connected and can change an angle between them to cause the proximal ends of the struts to have a distance between them that is substantially equal to a vertical spacing between the wall mount holes of a standard wall mount pattern.

12. The monitor bracket of claim 1, wherein the first elongated strut and the second elongated strut are pivotally connected and can change an angle between them to cause the proximal ends of the struts to have a distance between them that is substantially equal to a horizontal spacing of the wall mount holes of a standard wall mount pattern.

13. The monitor bracket of claim 1, wherein the cross support can be adjusted to allow the proximal ends of the struts to have a width substantially equal to a width of the wall mount holes of a standard wall mount pattern.

14. The monitor bracket of claim 1, wherein the attachment device at the proximal end of each strut comprises:
an attachment loop at the proximal end of each strut;
a threaded attachment device being one of a screw, bolt and stud that fits through the attachment loop and is secured into a wall mount hole.

15. The monitor bracket of claim 1, wherein the attachment device at the proximal end of each strut comprises:
an attachment loop proximal end of each strut;
a tamper-resistant threaded attachment device that fits through the attachment loop and is secured into a wall mount hole.

16. The monitor bracket of claim 1, wherein the elongated struts, pivot and extension arm are constructed from a recyclable material.

17. A method of attaching a sign to a monitor while protecting a front side of the monitor having a screen from damage comprising the steps of:
providing at least two struts each having a proximal end attached to a wall mounting recess on a back side of the monitor, with their other ends, the distal ends, attached together forming a triangular shape;
pivotally connecting a proximal end of an extension arm to the distal ends of the struts;
attaching a sign to the distal end of the extension arm;
biasing the extension arm into a display position when the monitor is upright, and biasing the extension arm toward a protective position in which the sign covers and protects the screen in the event that the monitor falls forward.

18. The method of claim 17, wherein the proximal end of the extension arm is pivotally attached to the distal end of the struts allowing the angle of the extension arm to be adjusted with respect to the struts.

19. The method of claim 18, wherein the proximal end of the extension arm is pivotally attached to the distal end of the struts with a pivot that locks in the protective position.

20. The method of claim 17, wherein the proximal end of the extension arm is attached to the distal end of the struts at an angle with respect to the struts that would cause the distal end of the extension arm to extend past the front face of the monitor to protect the screen.
